(19) United States
(12) Patent Application Publication
(10) Pub. No.: US 2012/0061529 A1
(43) Pub. Date: Mar. 15, 2012

(54) CLIP BRACKET

(76) Inventor: Douglas C. Hill, Brook Park, OH (US)

(21) Appl. No.: 13/232,189

(22) Filed: Sep. 14, 2011

Related U.S. Application Data
(63) Continuation-in-part of application No. 12/572,283, filed on Oct. 2, 2009.
Application No. 12/572,283 is a continuation of application No. 12/069,780, filed on Feb. 13, 2008, now Pat. No. 7,608,782.
Application No. 12/069,780 is a continuation-in-part of application No. 11/450,119, filed on Jun. 9, 2006, now Pat. No. 7,456,361.
(60) Provisional application No. 61/388,991, filed on Oct. 1, 2010.
(60) Provisional application No. 60/688,954, filed on Jun. 9, 2005.
(60) Provisional application No. 60/759,715, filed on Jan. 18, 2006.

(51) Int. Cl. F16L 3/08; B23P 11/00

(52) U.S. Cl. 248/65; 29/428

(57) ABSTRACT

A mounting system for securing a conduit to a structural object, the system including a first bracket element with a bendable configuration to produce an L-shaped first end portion and having a mounting tongue extending from a base leg, a second bracket element having a central bracket portion and a second end portion with a bendable configuration to form an L-shaped second end, a panel strap securable to the central portion and shaped to lockingly receive at least one clip for securing the conduit to the structural object, the mounting tongue being selectively joinable to at least one of the central portion and the panel strap to secure the first bracket element to the second bracket element.

This application is a continuation-in-part of U.S. patent application Ser. No. 12/572,283 filed on Oct. 2, 2009 which is still pending, and which in turn is a continuation of U.S. patent application Ser. No. 12/069,780, filed Feb. 13, 2008, now U.S. Pat. No. 7,608,782, issued Oct. 27, 2009, which in turn is a continuation-in-part of U.S. patent application Ser. No. 11/450,119, filed on Jun. 9, 2006, now U.S. Pat. No. 7,456,361, issued Nov. 25, 2008, which in turn claims priority to U.S. Provisional Application Ser. No. 60/688,954, filed Jun. 9, 2005, now expired, and U.S. Provisional Application Ser. No. 60/759,715, filed Jan. 18, 2006, now expired, all of which are incorporated by reference into this application. This application also claims priority to U.S. Provisional Application Ser. No. 61/388,991, filed on Oct. 1, 2010, which is incorporated by reference into this application.

The invention of this application relates to clips and brackets used to support these clips on structural objects. More particularly, to a new adjustable mounting bracket for supporting the clips and other similar devices disclosed in several prior applications owned by applicant.

Again, the invention of this application relates to the construction industry and the mounting of electrical wiring and other conduits to a structure. More particularly, to an adjustable mounting brackets for a clip system that can be used in connection with flexible armored electrical cable of all varieties (including or MC cable) and other conduits herein after all referred to as conduits.

### INCORPORATION BY REFERENCE

The present invention relates to electrical wiring other conduits and, more particularly, for a clip system for securing these conduit to a structural component of a facility. Coleman et al U.S. Pat. No. 5,189,719 discloses a rectangular flexible armored cable; Falciglia et al RE38,345 discloses a round flexible armored cable; and Dollins et al. U.S. Pat. No. 6,825,418 discloses a coded flexible armored cable. These patents are incorporated by reference herein as background information illustrating flexible armored cables including MC style cables and form part of this specification. Temblador U.S. Pat. No. 6,486,395 discloses a flexible armored cable with a special wiring configuration to illustrate that the invention of this application can be used in connection with all flexible armored cable, regardless of the wire gauge and/or wire configuration in the flexible armored cable, and is also incorporated by reference herein as background information and forms part of this specification. This application also incorporates by reference U.S. patent application Ser. No. 12/572,283 filed on Oct. 2, 2009 which is a continuation of U.S. application Ser. No. 12/069,780, filed Feb. 13, 2008 (now U.S. Pat. No. 7,608,782 issuing on Oct. 27, 2009), which application is a continuation-in-part of U.S. patent application Ser. No. 11/450,119 filed on Jun. 9, 2006 (now U.S. Pat. No. 7,456,361 issuing on Nov. 25, 2008) which application claims priority in U.S. provisional application Ser. No. 60/688,954, filed Jun. 9, 2005, entitled “CLIP” and U.S. provisional application Ser. No. 60/759,715, filed Jan. 18, 2006, all of which are incorporated by reference herein and form part of this specification.

### BACKGROUND OF THE INVENTION

The present invention is particularly applicable for use in connection with commercial installation of electrical wiring and, thus, will be discussed with respect to commercial applications. However, the invention of this application is not to be limited to commercial applications and/or wiring. In this respect, many commercial applications require some form of protection of the electrical wiring in a facility. For many years, electricians ran wire through rigid pipes. Now, with the development of flexible armored cable, rigid pipes are not needed. As can be appreciated, this eliminates the step of hanging rigid pipe and pulling the wire through the pipe. Further, since the armor is flexible, it can be easily manipulated around obstacles without jeopardizing the insulated qualities of the wire.

It is, of course, also well known that the electrical wiring in any facility must be insulated and secured to the structure in such a way that the electrical current is controlled and prevented from harming people and property. That is why virtually all electrical wiring sold includes some form of insulation. This can include the thin insulation surrounding the wire core and an outer layer of insulation surrounding the wire insulation. In some cases, the outer layer is made from a material similar to the wire insulation, such as a polymeric material. The wiring can also include a hard outer layer to further protect the wire. For the invention of this application, the wire includes a flexible armored outer layer to protect the wire. While the flexible armored layer, as is described in the above referenced patents, is typically made from a metallic material in today's electrical industry, it should be appreciated that the invention of this application could also be used in connection with non-metal flexible armored cables and other cables that could be used or will be used in the electrical industry.

While it has been found that flexible armored cables provide an efficient and effective means for wiring a facility with a protected electrical wire, the flexible armored cable must still be secured to the structure of the facility to be wired. This includes mounting the flexible armored cable to the studs in the facility, which could be wooden studs, but are typically metal studs in today's commercial construction projects. The mounting also includes mounting the flexible armored cable to ceiling structures and other structures. As can be appreciated, especially with commercial construction, the ceiling can be very high, wherein it is best to utilize mechanisms that are quick and easy to use, to minimize the time and expense of wiring a facility. Further, as can also be appreciated, mounting structures that only require one hand to use can be very beneficial since the other hand can be utilized to guide the cable and/or to maintain one's balance. Likewise, it is also time consuming and costly to install other forms of conduit.

Prior art clips have been created to help secure conduit to the facility; however, these clips are difficult to use, require tools and both hands. In addition, these prior art clips are costly.

### SUMMARY OF THE INVENTION

In accordance with the present invention, provided is an adjustable bracket for a clip system including a clip for flexible armored cable and other conduits. More particularly, provided is an adjustable bracket for a clip system wherein the clip is easily securable to a building's structural components and is configured to allow the conduit to be easily and quickly secured to the clip.

More particularly, provided is an adjustable bracket including a first side that is fixed and a second side that is removable wherein the removable side can be removed for a number of reasons including, but not limited to, adjusting the length of the overall bracket.

This bracket can be used with a range of clips including those disclosed in applicant's prior applications which form a part of this application and part of this invention. In this respect, the clip according to the present invention is for use with a conduit to secure the conduit to a structural object. The conduit has a central conduit axis and an outer armored layer extending about the conduit axis wherein the outer layer is formed from alternating crowns and troughs helically wound about the conduit axis such that the crowns and troughs are not perpendicular to the conduit axis. The clip, according to one aspect of the present invention, includes a longitudinally extending base with a bottom portion for engaging the structural object. The clip further includes a first end and a second end longitudinally spaced from the first end and a first side wall extending upwardly from the base between the first and second base ends. The first side wall includes a first inwardly extending surface forming a first portion of a longitudinally extending conduit cavity wherein the first portion has a first upper edge. The clip further includes a second side wall extending upwardly from the base between the first and second base ends and has a second inwardly extending surface forming a second portion of the conduit cavity. The second portion faces the first portion and has a second upper edge spaced from the first upper edge thereby forming a longitudinally extending entry gap for receiving the conduit that is opposite to the base. These first and second side walls are also bendable between a relaxed condition when the conduit is not positioned in the cavity and an engaged condition when the conduit is positioned in the cavity such that the conduit extends longitudinally through the cavity. The conduit cavity has a generally oval cross-sectional configuration when in the relaxed condition with a height between the bottom extent of the cavity and the entry gap and a width between the first and second inwardly extending surfaces wherein the height is greater than the width when in the relaxed condition. The clip can further including at least one transverse rib in the cavity configured to at least partially enter a trough in the conduit when the clip is in the engaged condition.

In accordance with another aspect of the present invention, provided is a clip for securing a conduit to a structural object which includes a longitudinally extending clip body having a generally C-shaped wire receiving cavity extending in the longitudinal direction and about the cavity axis with a longitudinally extending conduit receiving slot. The wire receiving cavity has a plurality of transverse ribs that are parallel to one another and each of these ribs has a first end and a second end that are circumferentially space about the cavity axis and which are longitudinally spaced. These ribs are configured to extend into a portion of a trough in the conduit.

### BRIEF DESCRIPTION OF THE DRAWINGS

The foregoing and more, will, in part, be obvious and, in part, be pointed out more fully hereinafter, in connection with a written description of preferred embodiments of the present invention illustrated in the accompanying drawings in which:

FIG. 1 is a perspective view of a clip in accordance with an aspect of the present invention;

FIG. 2 is a top, partially sectioned, view of the clip shown in FIG. 1;

FIG. 3 is a side, partially sectioned, view of the clip shown in FIG. 1;

FIG. 4 is a front view taken from lines 4-4 in FIG. 3;

FIG. 5 is a sectional view of the clip shown in FIG. 1 wherein a conduit is secured to the clip and the clip is secured to a wall stud;

FIG. 6 is a top, partially sectioned, view taken along lines 6-6 in FIG. 3;

FIG. 7 is a top, partially sectioned, view of the clip shown in FIG. 1 wherein a conduit is secured to the clip and the clip is secured to a wall stud;

FIG. 8 is a front view of another embodiment of the invention of this application;

FIG. 8A is a front view of yet another embodiment of the invention of this application with two clips on a single strap.

FIG. 9 is a side view of the clip shown in FIG. 8 wherein a conduit is secured to the clip and the clip is secured to a wall stud;

FIG. 10 is a top view of two clips wherein one clip is in position to be secured to a panel strap and the other clip is secured to the panel strap according to another aspect of the present invention;

FIG. 11 is a sectional view taken along lines 11-11 in FIG. 10;

FIG. 12 is a top view of another embodiment of a clip in accordance with another aspect of the present invention;

FIG. 13 is a side view of the clip shown in FIG. 12;

FIG. 14 is a front view of the clip shown in FIG. 12;

FIG. 15 is a perspective view of an adjustable bracket system according to further aspects of the invention of this application, the system is showed in the installed condition on two adjacent studs;

FIG. 16 is an exploded perspective view of the bracket shown in FIG. 15 in a flat condition;

FIG. 17 is a top view of the system shown in FIG. 15 wherein the bracket is in a formed condition with a single clip;

FIG. 18 is front view of the system shown in FIG. 17;

FIG. 19 is a sectional view taken from line 19-19 in FIG. 18;

FIG. 20 is a sectional view taken from line 20-20 in FIG. 18;

FIG. 21 is a perspective view of an end portion in a first formed condition on a supporting stud;

FIG. 22 is a perspective view of an end portion in a second formed condition on a supporting stud;

FIG. 23 is an enlarged exploded view showing another locking arrangement;

FIG. 24 is an assembled perspective view of the locking arrangement shown in FIG. 23;

FIG. 25 is a bottom view of the locking arrangement shown in FIG. 24;

FIG. 26 is a sectional view taken along lines 26-26 in FIG. 25; and,

FIG. 27 is a sectional view taken along lines 27-27 in FIG. 25.

### DESCRIPTION OF PREFERRED EMBODIMENTS

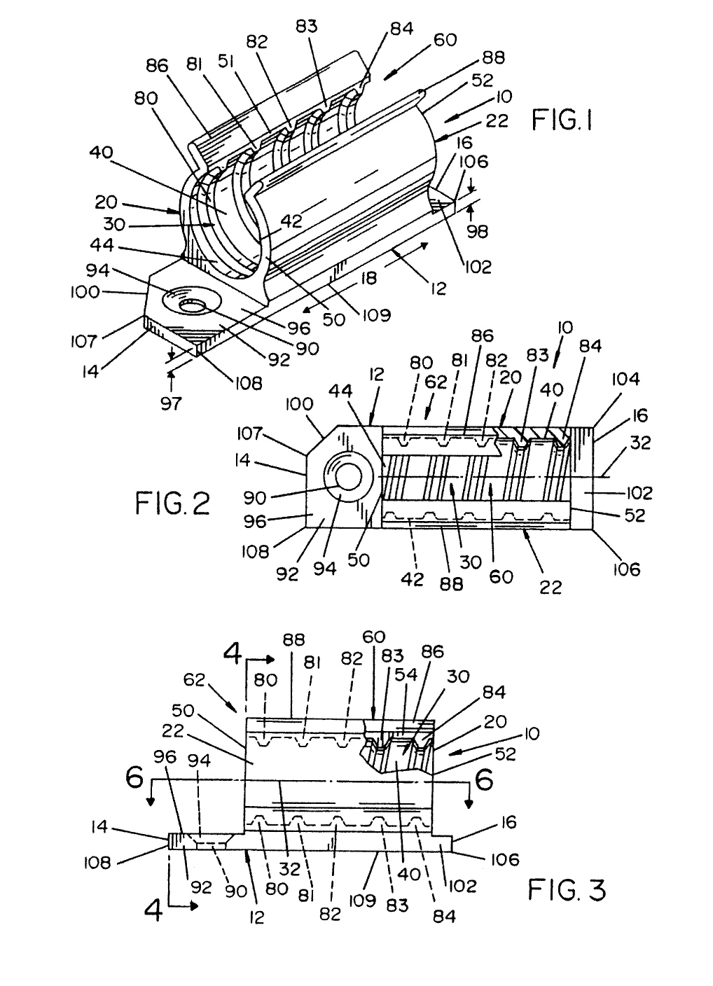

Referring now in greater detail to the drawings, wherein the showings are for the purpose of illustrating preferred embodiments of the invention only, and not for the purpose of limiting the invention FIGS. 1-7 show a clip 10 having a base portion 12 extending between an end 14 and an end 16 that together define longitudinal direction 18. Clip 10 further includes side walls 20 and 22 that also extend in the longitudinal direction.

Clip 10 further includes a conduit receiving cavity 30 that is oval or C-shaped which can extend from end 14 to end 16, but can be shorter. Cavity 30 is shaped to receive a section of an armored conduit or MC-cable C to secure conduit C to the clip such that the clip can be used to support the conduit on a structural object such as on a stud S. Cavity 30 extends circumferentially about a cavity axis 32. Cavity 30 is formed at least in part by inner surfaces 40 and 42 of walls 20 and 22, respectively. Inner surface portions 40 & 42 can be joined to one another or can be connected by a base surface portion 44 near base 12. Further, cavity 12 can be a smooth arcuate cavity or can be polygonal such that it is still generally C-shaped. As can be appreciated, and for example only, surface portion 40 or 42 could be formed by a plurality of non-parallel flat surface portions producing a polygonal cross-sectional configuration or could be formed by a unified arcuate surface without detracting from the invention of this application.

Again, cavity 30 extends longitudinally in direction 18 and is shown to extend between cavity ends 50 and 52. Cavity 30 extends circumferentially between top edges 54 and 56. While cavity 30 is shown to be continuous, cavity 30 does not need to be continuous and could include gaps, mounting arrangements etc. including, but not limited to, a central mounting hole (not shown) in the cavity to secure the clip to a structural object which will be discussed in greater detail below.

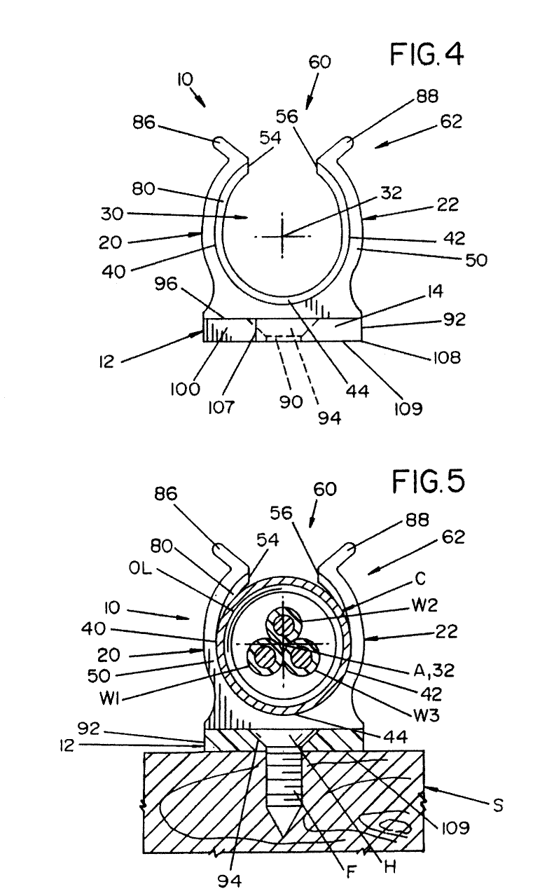

Top edges 54 and 56 at least in part form the edges of a top opening 60 sized to allow the conduit to enter cavity 30 with resistance. As can be appreciated, the size of this opening is dependent on the size of the conduit to be inserted. This opening can be a wide range of sizes and in one embodiment, the opening is between 0.23 inches and 0.33 inches and preferable around 0.28 inches when in a relaxed condition 62, as is shown in the several figures including FIG. 4. However, clip 10 is made from a material that can flex such that when the conduit is inserted into cavity 30, edges 54 and 56 will move away from one another based on the insertion force of the conduit which will temporarily enlarge opening 60 and cavity 30. This allows the conduit to be pressed into the clip. Once the conduit is moved through opening 60 and positioned in cavity 30, the clip moves inwardly around the conduit and automatically positions itself into an engaged condition 64, as is shown in FIG. 5 wherein at least a portion of the inner surfaces engage the conduit which will be discussed in greater detail below.

As is discussed above, the conduit can include a central conduit axis A wherein several wires extend generally parallel to this conduit axis. These conduits can be cables that can include three to five wires and as is shown, conduit C includes three wires W1, W2 and W3. Further, these wires can be different gauges. As a result, while many MC cables are standards, there could be different sizes of conduit and, therefore, different clip sizes. Further, the clip can be configured to work in connection with a number of differently sized MC cables and/or conduits which can require greater flexibility in design and/or materials. The wire are maintained within an outer armored layer OL extending about the conduit axis wherein the outer layer is formed from alternating crowns CR and troughs TR that can be helically wound about the conduit axis such that the crowns and troughs are not perpendicular to the conduit axis.

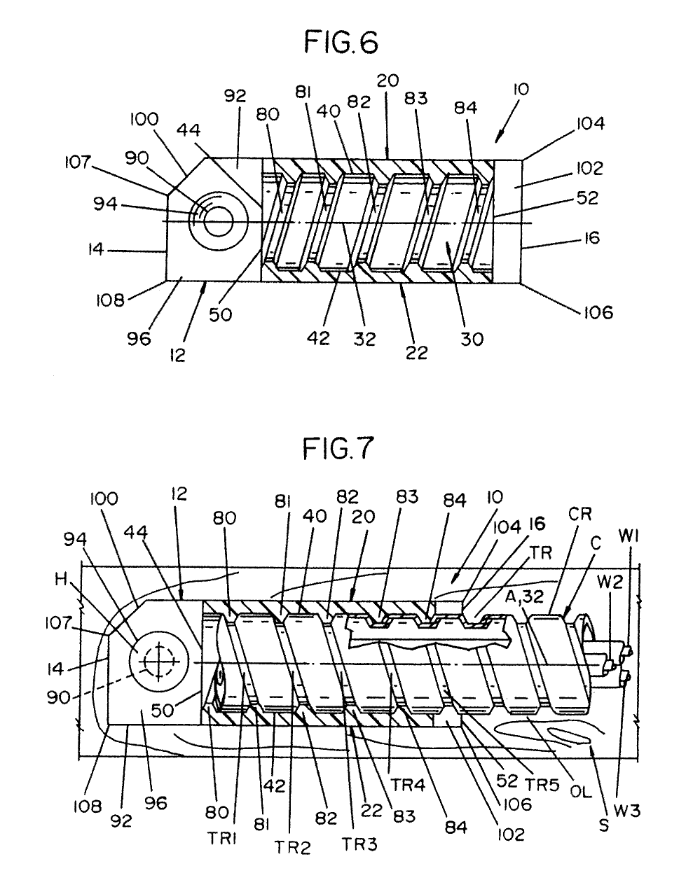

In order to meet some building codes, fastening devices, such as the clip of this application, need to secure the conduit such that it can withstand a given pulling load or pull test. In this respect, the clip must withstand an axial pulling load such that the conduit does not slip axial relative to the clip. In order to increase the pulling resistance of the clip, clip 10 can include a rib arrangement on the inner surfaces. In this respect, in one embodiment, clip 10 includes ribs 80-84. However, while five ribs are shown, more or less ribs could be utilized without detracting from the invention of this application. Further, the ribs can have more than one configuration and each rib does not need to be identical. In one embodiment, the ribs extend from near edge 54 to near edge 56 such that the ribs extend about a substantial portion of cavity 30. Further, as is best shown in FIG. 6, ribs 80-84 can have a helical slant that is the same or similar to the helical wrapping of certain cables. In this respect, the ribs can be at an angle to the cavity or conduit axis that is not 90 degrees. As can be appreciated, this configuration allows the ribs to better engage the crowns and troughs of the conduit. As can be also appreciated, the ribs do not need to extend from edge 54 to edge 56. These ribs could be short ribs that engage a small portion of the crown and trough arrangement of the conduit. In one embodiment (not shown), the ribs can be shortened ribs without significant helix wrap.

These ribs secure conduit longitudinally while the C-shape of the clip maintain the conduit axially. As can be appreciated, the use of ribs in the central portion of the clip requires the sides of the C-shaped portion to flex axially outwardly before the conduit can move substantially longitudinally along the conduit axis. This creates significant pull resistance by the clip without the need for complicated and/or difficult to engage mechanisms. In this respect, prior art clips require the end user to use a tool, either a screw driver or a pair of pliers, to properly secure the clip from movement in the longitudinal direction.

As can be appreciated, the longitudinal thickness of the rib or ribs can vary and can influence the desired angle of the rib. In this respect, thicker ribs should be configured more closely to the angle of the recess in the conduit while thinner ribs can have a rib angle that varies more from the actual angle of the recess in MC cables. As can be also appreciated, thinner ribs can also be used for clips designed for differently sized conduits or conduits produced by different manufacturers which have different ranges of tolerance.

The cross-sectional configuration of the ribs can be polygonal, such as the ribs shown or can be other configurations. Again, at least in part, the ribs' cross-sectional configuration is based on the configuration of the recesses in the MC cable. However, other cross-sectional configurations could also be used. As will be discussed in greater detail below, the clip can include in inner surface or surfaces that do not include these ribs.

The clip according to another aspect of the present invention can also include clip-opening flanges 86 and 88 near edges 54 and 56 respectively. These flanges can be used to create a ramp-like effect for the conduit to make it easier to force the conduit into the clip. As is discussed above, it is desirous that that conduit can be positioned in the clip with the use of only one hand. Further, it is also desired that the clip securely engage the conduit. These lead in tapers or clip-opening flanges on the open side of the C-shaped portion allow the clip to be opened by merely pushing the conduit axially against the open side of the C-shaped portion. The conduit will drive the sides of the C-shaped section away from each other until the conduit enters the clip, and then the walls will return toward their natural state. As can be appreciated, the walls may not reach their natural state when they reach the engaged condition which can be used to increase the gripping force on the conduit.

With reference to FIG. 7, when the clip is in the engaged condition, the ribs engage the crowns and/or the troughs of the conduit. More particularly, rib 80 is positioned to engage and/or enter at least a portion of trough TR1, rib 81 is positioned to engage and/or enter at least a portion of trough TR2, rib 82 is positioned to engage and/or enter at least a portion of trough TR3, rib 83 is positioned to engage and/or enter at least a portion of trough TR4, and rib 84 is positioned to engage and/or enter at least a portion of trough TR5. As can be appreciated, while the troughs are described as being different troughs, this is for illustrative purposes only in that the troughs of conduit C are typically helically wound such that the trough is a continuous trough. Further, the ribs can be designed to just enter the troughs wherein the inner surfaces 40, 42 and/or 44 engage the crown portion of the conduit. However, clip 10 could be configured to work in connection with any crown and trough arrangement including, but not limited to, independent crown and trough arrangements that are essentially perpendicular to the conduit axis.

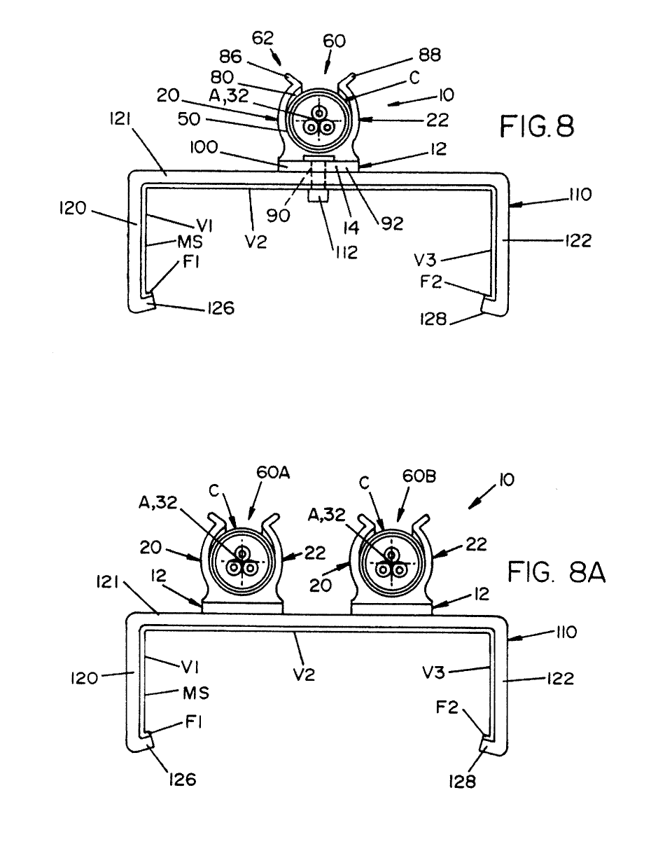

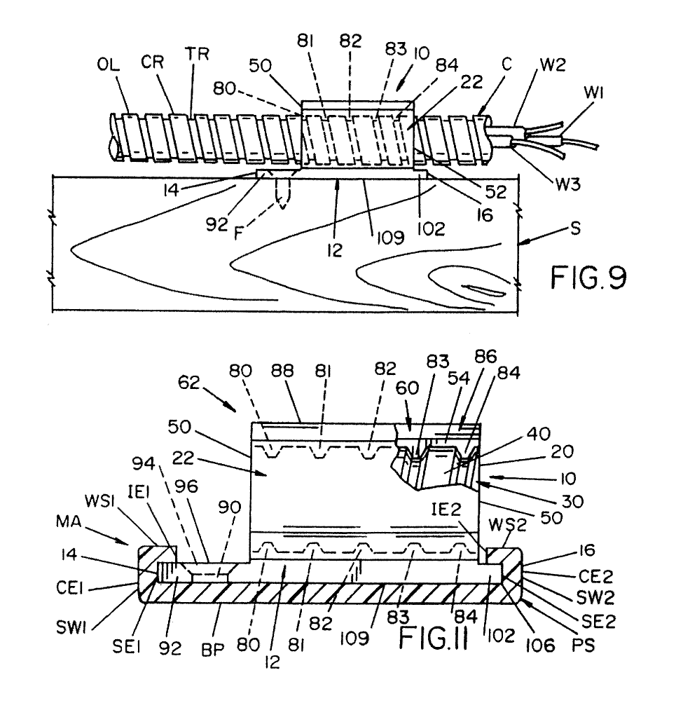

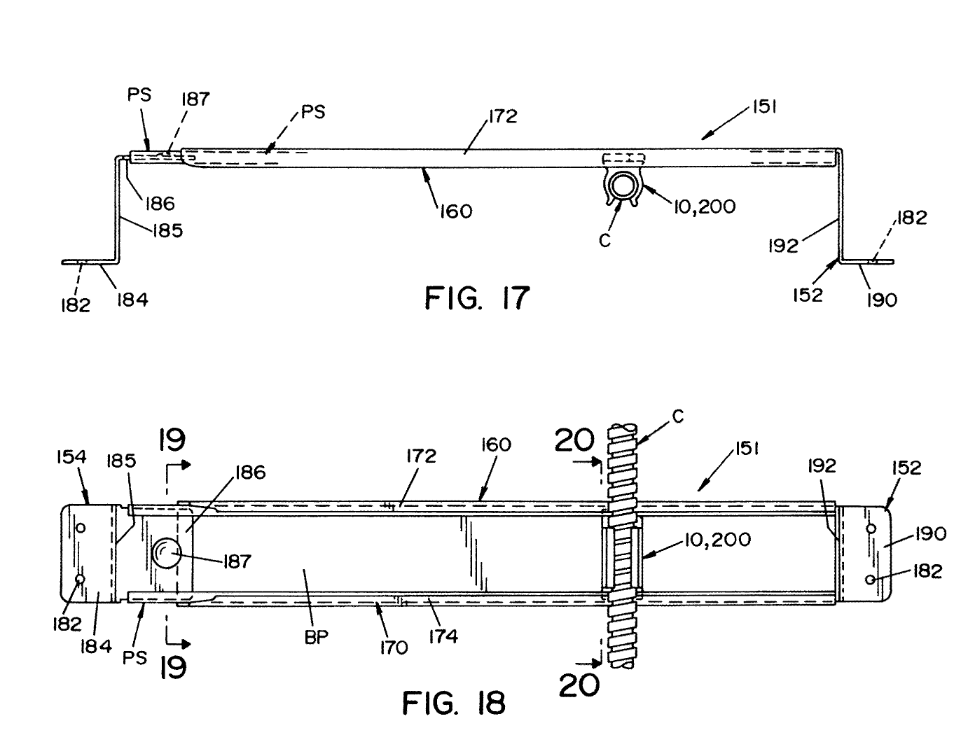

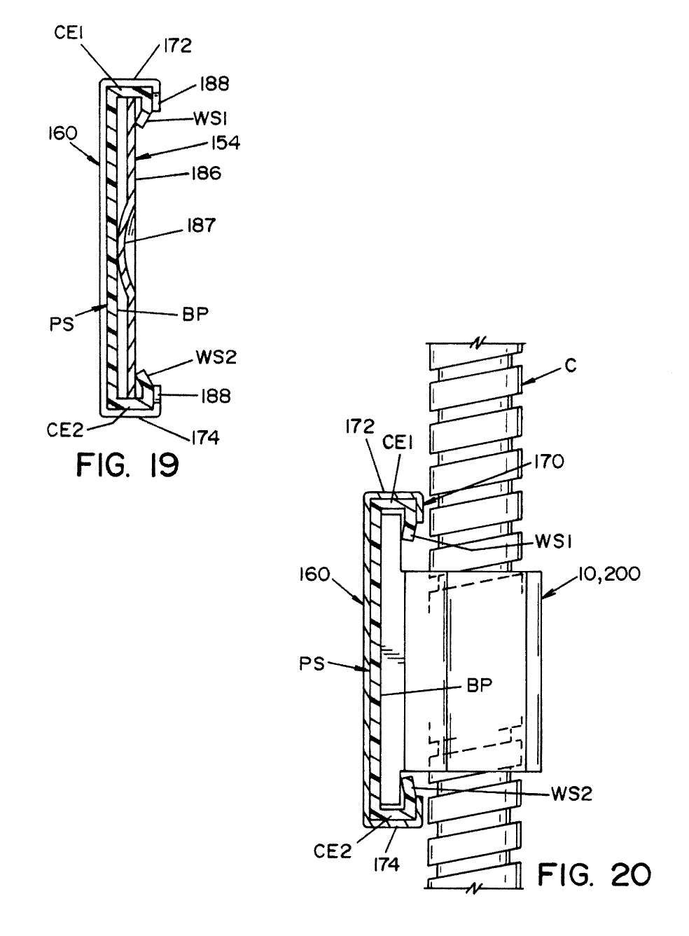

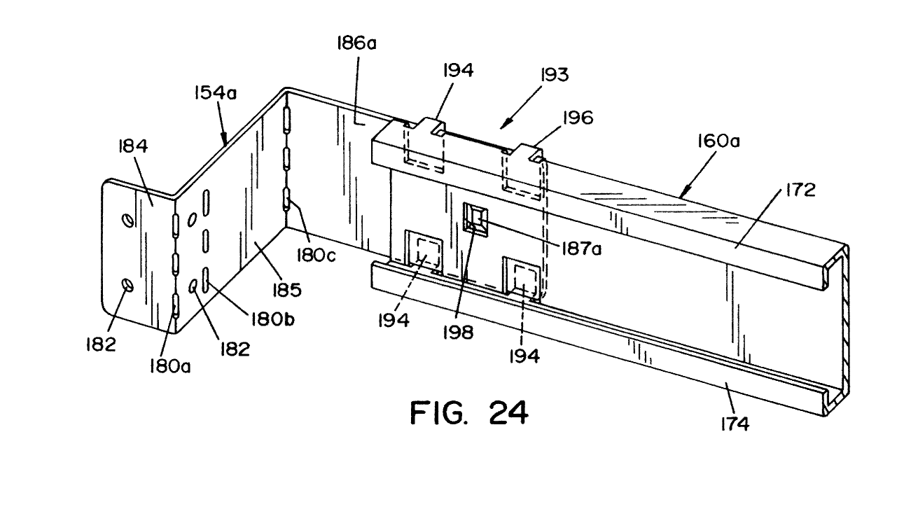

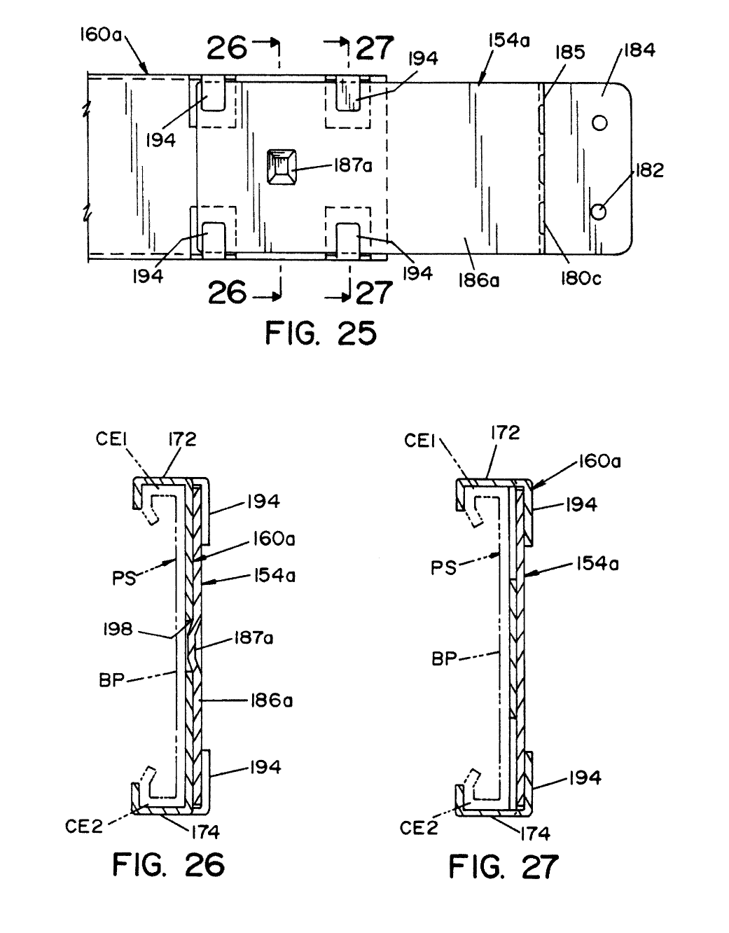

With reference to FIGS. 8-11 and 15-25, the clip of this application can be configured to be used in connection with a wide range of mounting arrangements. For example, the clip, according to yet another aspect of the present invention, can utilize any of a number of mounting holes including, but not limited to, a mounting hole 90 on an axially extending flange 92 that is offset from the C-shaped portion of the clip. This mounting hole can be configured to receive any fastener known in the art including, but not limited to, rivets, pop rivets, threaded fasteners and self locking or one-way style fasteners. Further, mounting hole 90 can further include a countersink portion 94 to allow a head H of a fastener F to be flush or below a top surface 96 of flange 92. As is discussed above, the mounting hole and mounting arrangement can also be any mounting arrangement known in the art without detracting from the invention of this application. This can include a self contained clip (not shown) or even multiple fastening arrangements (also not shown). In addition, the mounting hole can be positioned on other components of the clip without detracting from the invention of this application.

As is shown in FIGS. 8 and 8A, in another embodiment, the clip of this application can be configured to be used in connection with other fastening arrangements, such as a stud strap 110. The clip can be molded to the strap as a unified component (see FIG. 8A) or can be attached to the strap with any known fastener in the art (see FIG. 8). This can include, but is not limited to, use of a rivet 112 and/or a one-way locking fastener. This strap arrangement can be contoured and configured to lockingly interengage with a standard 3⅝ inch metal stud MS or other studs known in the art. The strap can also be configured to be fastened to a stud, by any known fasteners in the art. In greater detail, metal stud MS can include vertical members V1, V2 and V3 wherein members V1 and V3 include inward flanges F1 and F2. Stud strap 110 can include Strap sections 120-122 wherein clip 10 can be mounted to the strap portion 121 as is discussed above, such as by mounting hole 90. However, since the clip can be attached to the strap in an offsite operation, mass production techniques could be used to mount the clip to the strap such that other know mounting techniques could be used. As is shown, the clip could be riveted to the strap. Further, in one embodiment, the components can be molded together. The strap can be made from the same material as the clip or can be made from a different material. For example, the strap could be made from steel while the clip is made from a plastic. Strap 110 further includes a mounting arrangement to secure the strap and clip to a structural item of a building structure. This can include locking flanges 126 and 128 that extend inwardly from sections 120 and 122. In operation, the strap is positioned over the stud such that flanges “snaps” over the ends of members V1 and V2 of the stud. However, other mounting arrangements could be used to secure the strap to the stud. If the clip is preassembled onto the strap, simply snapping the strap over the stud can quickly secure clip 10 relative to stud MS.

The strap embodiment of this application can have a number of configurations. As is shown in FIG. 8, the strap can include a single clip mounted to the strap. However, in other embodiments as is shown in FIG. 8A, strap 110 can further include multiple clips on one strap without detracting from the invention of this application. Further, in yet another embodiment, a single strap can be configured to allow one, two, three or even more clips to be secured to a single strap based on the needs of the end user. This can include, but is not limited to, the strap having several spaced holes designed and shaped to receive a self-contained mounting arrangement in the clip or a separate fastener such as those described above, including, but not limited to, rivets. Further, the strap can be designed to be secured on either side of the metal stud.

The strap can be made from any material known in the art. This can include, but is not limited to, a metal or a plastic material, such as a non-destructive polymer plastic with fire retardant qualities having a non toxic burn.

In yet another embodiment, the fastening arrangement for the straps and/or the clip themselves can be configured to allow partial or full rotation of the clip about a desired axis. In this respect, the fastening arrangement used for the clip and/or the strap can allow the clip to rotate about an axis extending upwardly from the base of clip to allow the clip and the conduit to rotate about an axis transverse to the wire axis. This can provide a clip that is easily rotatable or positionable to allow easy adjustment. Essentially, the rotation is based on the direction that the conduit is being laid and the position of the next clip, and the rotation can be initiated by a tug on the conduit near the next clip. For example, if the conduit is being positioned near a corner or bend in the electrical line, it can be advantageous for the clip, based on the angle the end user pulls on the conduit, to automatically rotate a desired amount while maintaining the conduit securely at the point of attachment to the clip. Further, this rotation can be achieved when the end user is working on the next clip without the need to go back to the previous clip. As is discussed in greater detail above, the ribs within the C-shaped portion prevent the conduit from pulling longitudinally out of the clip during the rotational adjustment of the clip.

In a further embodiment, the rotatable clip could also include a second mounting arrangement including, but not limited to, a second mounting hole (not shown), to lock the clip relative to the stud to prevent rotation after the job is completed. As can be appreciated, this second mounting or securing hole can be spaced from the conduit axis or the clip axis so that it can be accessed when the conduit is in the engaged condition.

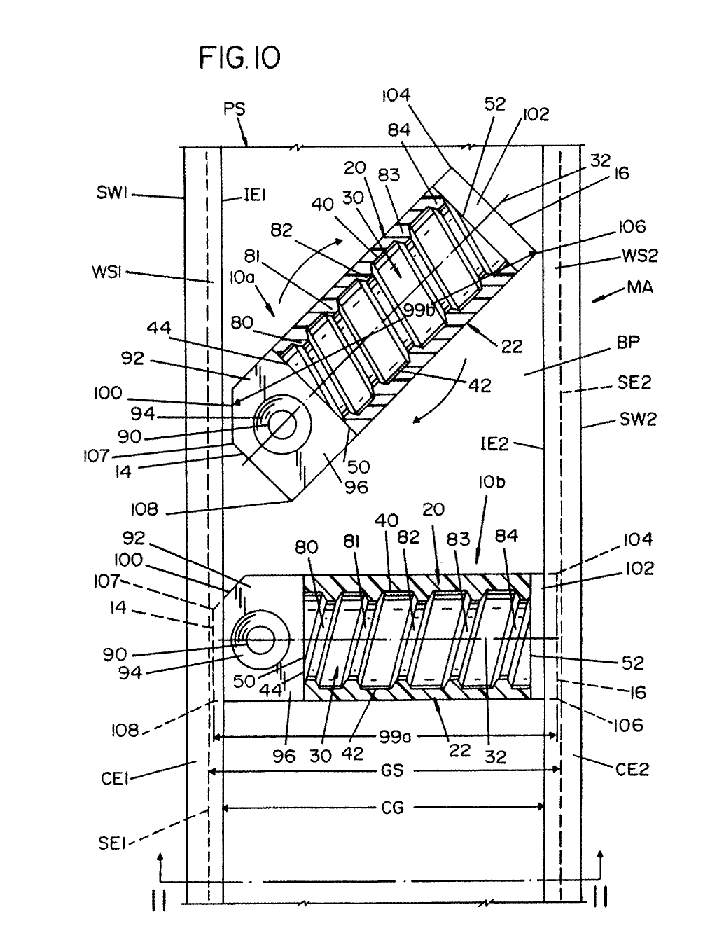

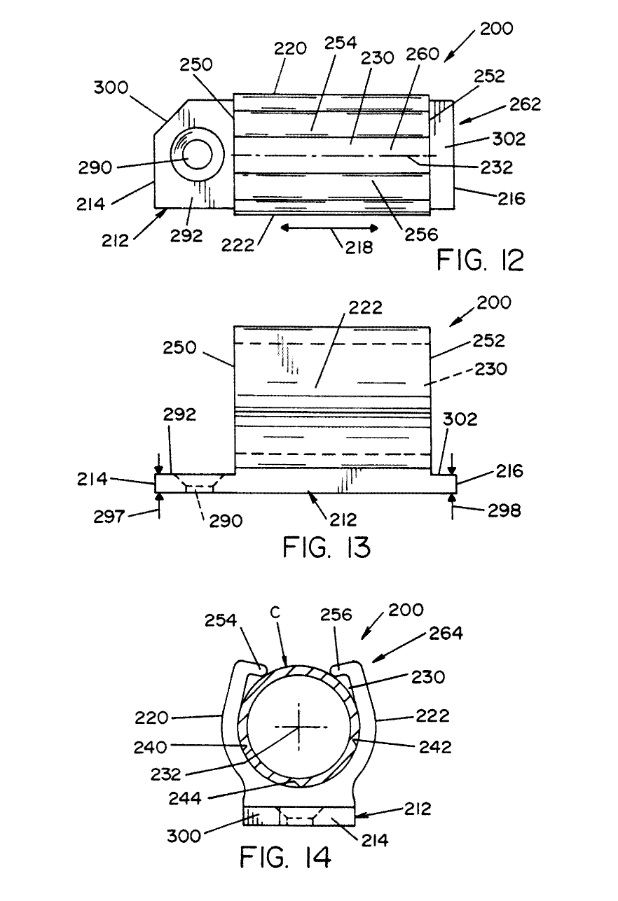

As is shown in FIGS. 10 and 11, in yet another embodiment, the clip of this application can be configured such that it locks into a panel strap PS. In this respect, shown is a mounting arrangement MA including panel strap PS and clip 10. Panel strap PS can include a base plate BP and opposing channel ends CE1 and CE2 that are spaced from base plate BP thereby forming gaps therebetween shaped to receive the clip. More particularly, panel strap PS includes side walls SW1 and SW2 that extend upwardly from base plate BP side edges SE1 and SE2, respectively. Panel strap PS further includes upper wall sections WS1 and WS2 extending inwardly from side walls SW1 and SW2, respectively, such that side wall SW1 and wall section WS1, together with a portion of base plate BP, form channel end CE1 and side wall SW2 and wall section WS2, together with a portion of base plate BP, form channel end CE2. Channel ends CE1 and CE2 further include inner edges IE1 and IE2, respectively. Inner edges IE1 and IE2 are spaced from one another a distance CG.

Shown in FIG. 10 are clips 10a and 10b which can include a corner cut 100 in flange 92 and a back side flange 102 wherein flanges 92 and 102 have a thickness 97 and 98, respectively, that are less the thickness of these gaps in the channel ends such that the flanges can enter these gaps. In addition, flange 102 can further include flange corners 104 and 106, and flange 92 can further include flange corners 107 and 108. Clip 10 has a length 99a that, in one embodiment, is greater than a gap spacing GS between side walls SW1 and SW2 which will be discussed in greater detail below. Clip 10 can further include a cattycorner length 99b between corner cut 100 and corner 106 that can be, in one embodiment, less than channel gap CG. This configuration allows the clip to be twisted into panel strap PS which will be discussed in greater detail below.

With reference to clip 10a, the clip can be oriented such that corner 106 is positioned in or near channel end CE2 wherein corner cut 100 of flange 92 is adjacent to inner edge IE1 to allow flange 92 to clear channel end CE1. As corner cut 100 clears channel end CE1, a clip bottom surface 109 can be urged against base plate BP. Once in this position, clip 10a can then be twisted clockwise relative to panel strap PS until flanges 92 and 102 snap into channels CE1 and CE2, respectively, as is shown with clip 10b. More particularly, as the clip is twisted, corner 107 of flange 92 and corner 106 of flange 102 engage side walls SW1 and SW2, respectively, such that the clips snaps into engagement with the channels and the clip is held in place relative to the strap. As is discussed in this application, the clips of this application can be used for a wide range of conduits and sizes of conduits including a variety of electrical and even a variety of non-electrical conduits. Accordingly, and as can be appreciated, more than one type and/or size of clip can be used with a single size of panel strap. This allows a single panel strap to be connected to a structural portion, such as a stud, and a range of clips to be attached to this single strap.

In yet another embodiment, the clip can be configured such that another portion of the clip, such as edge 52, engages channel edge IE2 to create the engagement between the clip and the panel strap. In even yet another embodiment, the clip and the panel strap can be configured to produce a resistance fit between the clip and the panel strap such that the clip cannot be easily moved relative to the strap once it is snapped into place. In a further embodiment, the channels of the strap can have non-parallel portions. In this respect, channels CE1 and CE2 can include a downwardly extending portion such as a downwardly extending channel end to engage the clip.

As can be appreciated, clips 10a and/or 10b could also be reversed such that they are oriented with flanges 92 and 102 locked into channels CE2 and CE1, respectively. Once locked in place, clip 10 can be secured relative to the panel strap. By utilizing panel strap PS, one or even several clips can be quickly positioned and secured at a given location such as near an electrical panel (not shown).

In even yet another embodiment, the configuration of the clips according to the present invention can also be modified to matingly engage with mounting devices known in the industry or mounting devices which will be used in the industry.

With reference to FIGS. 10, 11 & 15-27, shown is yet another bracket design according to yet other aspects of the invention. More particularly, shown is a mounting system 150 having a support bracket 151 that can be an adjustable support bracket. Further, the adjustability can be multifold wherein bracket 151 can be configured to both change shape, set back and/or length. In the embodiments shown, the system is configured to mount to two adjacent studs 51 and S2; however, this system can be configured to mount to a wide range of structures wherein it should not be limited to studs of a stud wall. The system further includes at least one clip that can include clips 10a & 10b shown in FIG. 15 and FIGS. 1-6. However, a wide range of clips could be utilized include clip 200 shown in FIGS. 12-14.

In one set of embodiments, bracket 151 is an adjustable bracket for use with one or more of the conduit clips of this application and others. The bracket can include a fixed end portion 152 and an adjustable end portion 154 (or two of either) with a central panel strap portion 160 between end portions 152 and 154. End portions 152 and 154 along with central portion 160 can be formed by sheet metal to allow for sturdy construction and to allow for adjustment features discussed below.

Central portion 160 can include one or more panel straps PS (or variations thereof) that work as is described above with respect to other embodiments of this application wherein it will not be described in detail with respect to this embodiment in the interest of brevity.

As is shown, panel strap PS can be parallel to sections 152 and 154 and section 160 and can be longer than central portion 160.

In these sets of embodiments, central portion 160 includes a securing arrangement 170 to secure panel strap PS to the central portion. Panel strap PS can be joined to central portion 160 by any means known in the art including, but not limited to, snap lock, inner rails, fasteners, adhesives and/or clips. However, it has been found that the system works particularly well with securing arrangement 170 being formed by inwardly facing rails 172 and 174 that are formed from central portion 160. These rails can both increase the rigidity of the central portion and provide an easy and quick method to secure the panel strap to the bracket. Essentially, the side edges of the panel straps are engaged and held by rails 172 and 174. As will be discussed more below, sections 152 and 154 can be utilized to prevent sliding of the panels strap relative to the central portion. As a result, the panel strap can be quickly positioned in the central portion and can be quickly locked in place by the bending of the end portions into their L-shaped configuration. Further, the length of the system and/or the panel strap can be quickly modified before installation.

Further, while not shown, bracket 151 can include other features without detracting from the invention of this application. These can include, but are not limited to, stiffening ridges or ribs, clips, alignment tabs, color coding, material changes for different environments, alignment and/or stabilizers for installation.

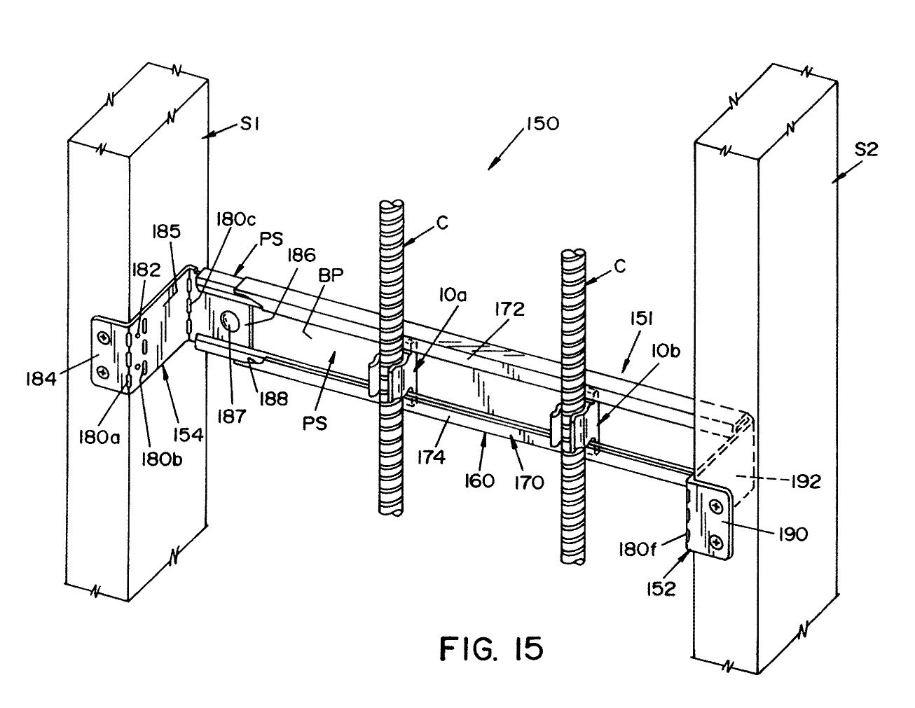

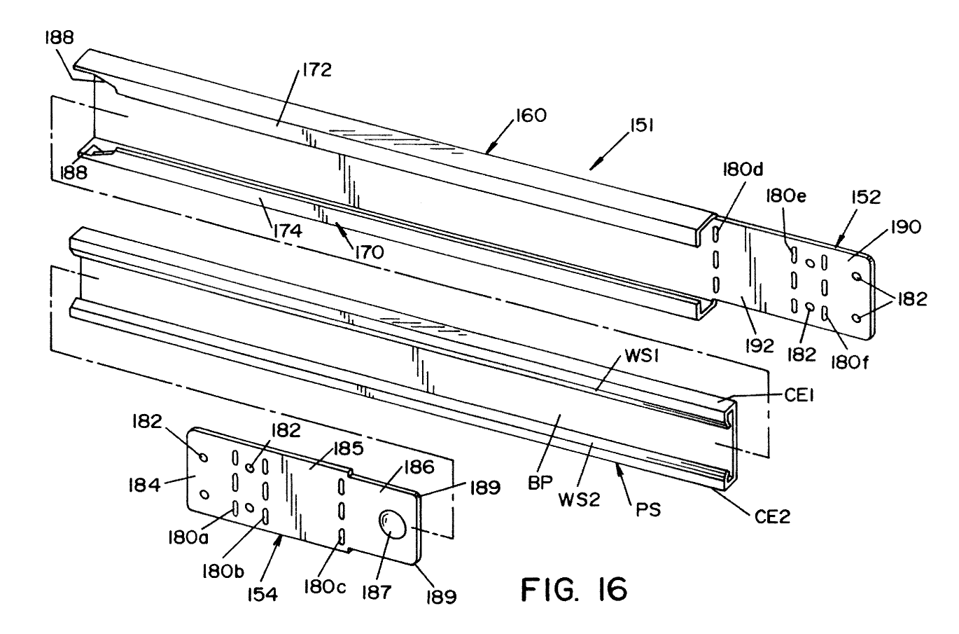

In one set of embodiments, end portion 152 can be formed from central section 160 as a unified component wherein a single metal strip can form end portion 152, central portion 160 and rails 172 & 174. Further, system 150 can be sold and/or used in its flat condition shown in FIGS. 16 & 23 or in the formed condition shown in FIG. 15.

In one set of embodiments, system 150 is produced and/or sold in its generally flat condition (except for rails 172 & 174) wherein the system can be formed on-site wherein adjustments can be made based on the structural object the system is to be mounted to. This arrangement can include one or more bending features 180 that can allow the end user to easily bend one or both ends of the bracket onsite. The bending features allow for customization onsite and/or reduced shipping costs. While oval bending holes are shown, the bending features of this application can be any bending structure to help align and/or form the bends of the bracket to produce the formed bracket including, but not limited to, more or less holes, perforations, lines (formed and/or marked), changes in thickness, notches, changes in material property such as hardness and the like. As a result, the bracket can be easily changed from a flat bracket to a formed bracket during manufacturing and/or onsite have L-shaped end portions. As can be appreciated, if only formed brackets are desired, these bends could be produced during manufacturing to reduce onsite costs with or without bending features. While not shown, the bracket also can include additional bend points as needed or desired by the end user without detracting from the invention of this application.

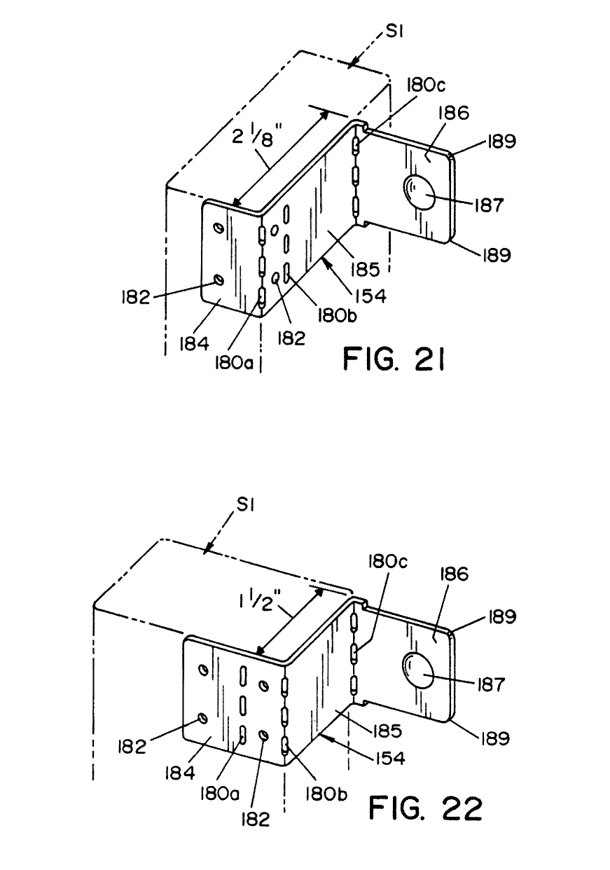

As is known in the art, there are building codes that necessitate certain spacing between conduits and other structural object. This can include a designated set back that is needed for the bracket of this application. As is shown, the bracket can include multiple bending features and this can include multiple bending features to modify the set back of the system from a stud face. As is shown, both end portions 152 and 154 include bend feature for both producing a 1½ inch set back and a 2⅛ inch set back. The multiple set back feature also allows the system to be used on studs regardless of the stud's orientation relative to the front surface of the stud wall as is shown in FIGS. 21 & 22). Thus, the end user can form these sections based on the desired set back of the system. In all, the embodiments shown include three bending features for each end that allow for the formation of the L-shaped end portion and the bend between the end portions and the central portion.

In yet other embodiments, the end portions can include markings 181 to note discretionary bends for onsite bending. The system can further include mounting holes 182 to secure the bracket to structural objects including, but not limited to, studs (both metal and wood) to help secure the bracket relative to these structural items. Further, the bracket could also include any mounting and/or alignment feature known in the art to align and/or secure (temporarily and/or permanently) the bracket as desired.

In greater detail, end portion 154 can be formed from a single piece of sheet metal and can include bending features 180a, 180b & 180c that can separate end portion 154 into an outer portion 184, a base portion 185, and a mounting tongue 186. As discussed above, bending features 180a & 180b are discretionary bends that can be used to modify the set back of the system. When in the formed shape (shown in FIGS. 15, 17 & 18), outer portion 184 and tongue 186 are generally parallel to one another in parallel spaced planes. Further, when in the assembled condition, tongue 186 is generally in the same plane as central portion 160 even though, based on the mounting mechanism used, can be offset slightly.

Tongue 186 can further include one or more locking features 187 and can also be utilized to modify the overall length of the system by allowing adjustment to the engagement length between the tongue and the central portion. Locking feature 187 can be a detent formed in tongue 186 that can create resistance between the tongue and the central portion. In the embodiment shown, the detent can be a rearwardly facing detent such that detent 187 frictionally engages base plate BP of panel strap PS. This engagement forces tongue 186 into a frictional engagement with upper wall sections WS1 and WS2 as the tongue is slid into the opposing channel ends CE1 and CE2 of the panel strap PS. In view of this frictional engagement, end portion 154 is at least maintained relative to central portion 160 long enough to secure the system to the associated structural objects, such as studs 51 & S2. However, while not shown, the system could include locking arrangements to lock portion 154 to portion 160. These can include, but are not limited to, a locking detent, a locking barb, a fastener and/or adhesives which can be removable or permanent as is desired. The system can further include lead in tapers 188 and 189 to aid in the alignment of tongue 186 into central portion 160.

Similarly, end portion 152 can be formed from a single piece of sheet metal and can include bending features 180d, 180e & 180f that can separate end portion 152 into an outer portion 190 and a base portion 192. While not shown, end portion 152 can also include a tongue portion and can be configured at least similar to end portion 154. As shown, bending feature 180d can separate central portion 160 from end portion 152 and allow base portion 192 to extend transversely to the central portion and the outer portion. As discussed above, bending features 180e & 180f are discretionary bends that can be used to modify the set back of the system. Further, all bend features could be discretionary in that the system could be used in the flat state. When in the formed condition (shown in FIGS. 15, 17 & 18), outer portion 190 and central portion 160 are generally parallel to one another in parallel spaced planes.

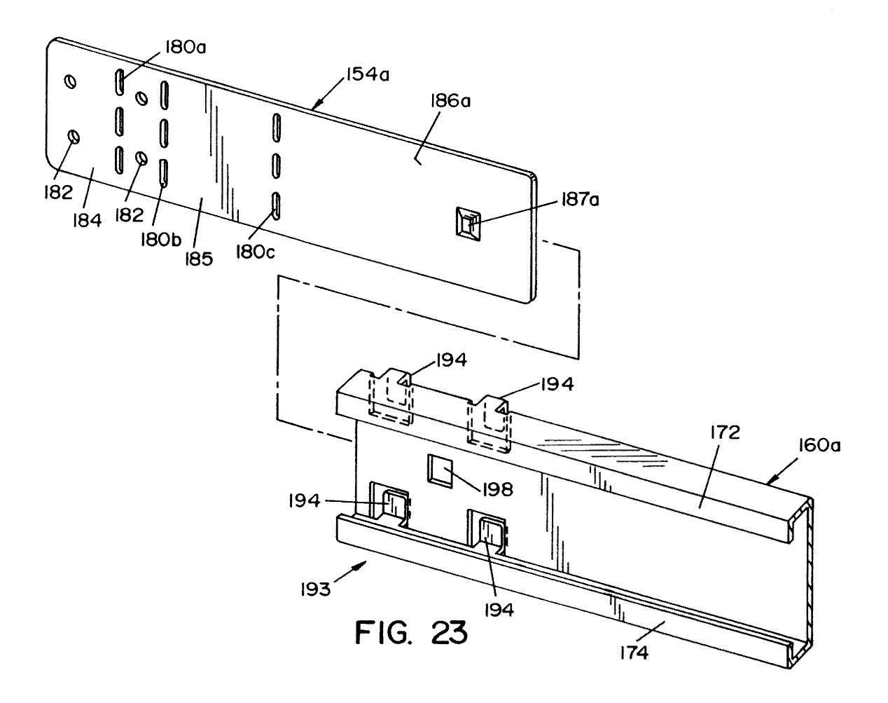

With reference to FIGS. 23-27, shown is another locking arrangement. In this respect, shown is a locking arrangement 193 including tabs 194 in a central portion 160a such that tongue 186a joins directly to central portion 160a and not panel strap PS. Further, tongue 186a includes can including a locking tab 187a that can engage an opening 198 in central portion 160a. This can create a locking arrangement or a resistance fit as is described above. While the remaining portions of the system could be the same, this arrangement does not utilize the panel strap to hold the system together.

Again, the system can include length markings to aid in the shortening of the bracket based on known stud spacings, building codes or other known conditions. This can include merely marking the section for different desired and/or known lengths. Further, in yet other embodiments, bracket 150 can be a set of brackets sold in different lengths. Yet even further, length adjustment could also include a feature similar to the bending features discussed above wherein the length can be shorted by repeated bending of the piece to be shortened until the portion to be removed snaps off. Or, the bent section could merely be folded out of the way of the remaining bracket sections. Further, section 154 and/or 160 can include multiple locking features so that a desired length of bracket 151 can be easily produced by pushing section 154 into section 160 (for any embodiment) until the desired length is achieved and the corresponding locking feature is engaged. This can be done during manufacture and/or onsite. Yet even further, the sliding arrangement between the panel strap PS and central portion 160 can allow the system to be easily lengthened by merely pulling the components apart as needed. While, this adjustment has its limits, it can easily accommodate variations in stud spacings which are known in this field. Further, the panel strap and/or central portion can be shortened by providing the shortening features discussed above or by merely using a saw to shorten these components as needed. In that these components are easily assembled and disassembled regardless of the length of these components, these modifications are still relatively easy and can allow this system to be utilized in a wide range of environments and situations.

The system can be produced from any materials known in the art including, but not limited to, sheet metal and galvanized steel sheet. In one set of embodiments, the metal portions can be produced by 24 gage galvanized steel and panel strap PS can be formed by a polycarbonate plastic. Further, in that one end is fixed while the other end is removable, the bracket can be cut to desired length including taking the bracket apart, cutting to the desired length and then reassembling the bracket. The bracket can be designed to secure (as discussed above) to a wide range of products including, but not limited to, those sold by Time Saver Products under the names AG840, KM28, KM30, and/or KM32 for support in-between wood or metal studs. Further, while the panel strap versions are shown, other locking configuration for securing a clipping device to the bracket can be used without detracting from the invention of this application.

With reference to FIGS. 12-14, shown is yet another embodiment of the invention of this application. In this respect, shown a clip 200 having a base portion 212 extending between an end 214 and an end 216 that together define longitudinal direction 218. Clip 200 further includes side walls 220 and 222 that also extend in the longitudinal direction.

Clip 200 further includes a conduit receiving cavity 230 that is oval or C-shaped which can extend from end 214 to end 216, but can be shorter. Cavity 230 is shaped to receive a section of an armored conduit or MC-cable C to secure conduit C to the clip such that the clip can be used to support the conduit on a structural object such as on stud S. Cavity 230 extends circumferentially about a cavity axis 232. Cavity 230 is formed at least in part by inner surfaces 240 and 242 of walls 220 and 222, respectively. As with other embodiments, inner surface portions 240 & 242 can be joined to one another or can be connected by a base surface portion 244 near base 212. Further, cavity 230 can be a smooth arcuate cavity or can be polygonal such that it is still generally C-shaped. As can be appreciated, and for example only, surface portion 240 or 242 could be formed by a plurality of non-parallel flat surface portions producing a polygonal cross-sectional configuration or could be formed by a unified arcuate surface without detracting from the invention of this application.

Again, cavity 230 extends longitudinally in direction 218 and is shown to extend between cavity ends 250 and 252. Cavity 230 extends circumferentially between top inwardly facing barbs 254 and 256. While cavity 230 is shown to be continuous, cavity 230 does not need to be continuous and could include gaps, mounting arrangements etc. including, but not limited to, a central mounting hole (not shown) in the cavity to secure the clip to a structural object which will be discussed in greater detail below.

Barbs 254 and 256 can at least in part form the edges of a top opening 260 sized to allow the conduit to enter cavity 230 with resistance. As can be appreciated, the size of this opening is dependent on the size of the conduit to be inserted. This opening can be a wide range of sizes and in one embodiment, the opening that is sized based on the size of the conduit to be secured when in a relaxed condition 262. However, clip 200 is made from a material that can flex such that when the conduit is inserted into cavity 230, barbs 254 and 256 move away from one another based on the insertion force of the conduit which will temporarily enlarge opening 260 and cavity 230. This allows the conduit to be pressed into the clip. Once the conduit is moved through opening 260 and positioned in cavity 230, the clip moves inwardly around the conduit and automatically positions itself into an engaged condition 264, as is shown in FIG. 14 wherein at least a portion of the inner surfaces engage the conduit which will be discussed in greater detail below.

As with the other embodiments, clip 200 can be configured to be used in connection with a wide range of mounting arrangements. In this respect, clip 200 can utilize any of a number of mounting holes including, but not limited to, a mounting hole 290 on an axially extending flange 292 that is offset from the C-shaped portion of the clip. This mounting hole can also be configured to receive any fastener known in the art including, but not limited to, rivets, pop rivets, threaded fasteners and self locking or one-way style fasteners. Further, mounting hole 290 can have a countersunk portion. This can include further include any other mounting arrangement discussed in this application. This includes, but is not limited to, being configured to be used in connection with stud straps 110 as are discussed above. Clip 200 can also be configured to allow partial or full rotation of the clip about a desired axis as is discussed above. Yet even further, clip can be used in combination with panel strap PS discussed above. In this respect, clip 200 can further include a corner cut 300 in flange 292 and a back side flange 302 wherein flanges 292 and 302 have a thickness 297 and 298, respectively, that are less the thickness of the gaps in the channel ends such that the flanges can enter these gaps. As is discussed in greater detail above, this configuration can be used to lockingly secure clip 200 to panel strap PS.

In even yet another embodiment, the configuration of the clips according to the present invention can also be modified to matingly engage with mounting devices known in the industry or mounting devices which will be used in the industry.

The clip of this application can have many configurations or modification without detracting from the invention of this application. For example, the flanges, such as flange 92, can have many different configurations including the four sided polygonal configuration described with respect to one of the embodiments above, a rectangular configuration, a semi-circular configuration or even combinations thereof. As discussed above, these configurations can be used for a mounting hole, such as mounting hole 90, and/or can be used for the mating engagement with other object such as the use of flanges 92 and 102 to engage a panel strap. Further, this configuration can be based on manufacturing techniques to simplify the manufacturing process such as configurations that allow the clip to be extruded.

The material used for the clip can be any known material in the art including, but not limited to, a plastic clip material that is flexible with memory such as a non destructive polymer plastic with fire retardant qualities that is non toxic.

While considerable emphasis has been placed on the preferred embodiments of the invention illustrated and described herein, it will be appreciated that other embodiments and/or equivalents thereof can be made and that many changes can be made in the preferred embodiments without departing from the principals of the invention. Accordingly, it is to be distinctly understood that the foregoing descriptive matter is to be interpreted merely as illustrative of the invention and not as a limitation.

It is claimed:

1. A mounting system for securing at least one conduit to a structural object, the conduit having a central conduit axis and an outer layer extending about the conduit axis, the system comprising:
a support bracket having a first end portion and a second end portion with a central portion between the first and second end portions, the first end portion being configured to be selectively securable to a first associated structural object and the second end portion being configured to be selectively securable to a second associated structural object spaced from the first associated structural object, the central portion of the support bracket including a strap support;
a panel strap shaped to be received and secured in the strap support of the support bracket, the panel strap including a base plate and inwardly extending first and second side channels, the first and second side channels of the panel strap each including inner edges facing one another thereby defining a clip receiving gap, the each channel further including outer side walls spaced from one another by an end wall spacing and facing one another, the clip receiving gap being less than the end wall spacing; and,
at least one clip having a longitudinally extending clip body extending between a first and a second clip end thereby defining a clip length, the at least one clip including a conduit receiving cavity extending about a cavity axis such that the cavity includes a conduit receiving slot parallel to the cavity axis, the conduit receiving cavity being shaped to receive an associated conduit, the at least one clip further including a first longitudinally extending flange at the first end and a second longitudinally extending flange at the second end, the first flange having a first transverse outer edge at least partially defining the first end and the second flange having a second transverse edge at least partially defining the second end, the first flange further including a first corner portion and a second corner portion, the second flange including a third corner portion and a fourth corner portion such that the first corner portion is cattycornered to the third corner portion defining a clearance length of the clip and the second corner portion is cattycornered to the fourth corner portion defining a locking length of the clip, the clearance length being less than the locking length and less than the clip receiving gap such that the at least one clip can be received in the panel strap, the locking length being greater than the end wall spacing of the panel strap wherein the at least one clip can be rotated relative to the panel strap to substantially lock the at least one clip relative to the panel strap.

2. The mounting system according to claim 1, wherein the central portion generally extends in a central plane and the first end portion is L-shaped having a first base leg adjacent to a first end of the central portion and a first outer leg joined to the base leg, the outer leg extending in an outer plane that is generally parallel to the central plane but spaced therefrom.

3. The mounting system according to claim 2, wherein the second end portion is L-shaped having a second base leg adjacent to a second end of the central portion and a second outer leg joined to the second base leg, the second outer leg generally extending in the outer plane.

4. The mounting system according to claim 3, wherein the second end portion is a unified structure with the central portion and the first end portion is selectively connectable to the central portion.

5. The mounting system according to claim 4, wherein the central portion has a central portion length and the central portion length is adjustable, the first end portion being connectable to the central portion after the central portion is adjusted.

6. The mounting system according to claim 2, wherein the first end portion further includes a mounting tongue extending from the first base leg and transverse to the first base leg, the mounting tongue being selectively connectable to the first end of the central portion.

7. The mounting system according to claim 2, wherein the mounting tongue is shaped to be received in the inwardly extending first and second side channels of the panel strap to join the first end portion to the central portion.

8. The mounting system according to claim 7, wherein the mounting tongue includes a detent to produce a resistance fit between the mounting tongue and the panel strap.

9. The mounting system according to claim 1, wherein the central portion includes inwardly facing side rails extending along a central plane that face one another, the panel strap slidingly engaging the inwardly facing side rails to at least partially secure the panel strap relative to the central portion.

10. The mounting system according to claim 9, wherein the inwardly facing side rails are on a front face of the central portion, the first end portion being L-shaped having a first base leg adjacent a first end of the central portion and extending forwardly from the central portion, the first end portion further including a first outer leg joined to the base leg, the outer leg extending in an outer plane that is generally parallel to the central plane but spaced forwardly therefrom, the second end portion being L-shaped having a second base leg joined to a second end of the central portion and a second outer leg joined to the second base leg, the second outer leg generally extending in the outer plane, the first and second base legs preventing the panel strap from sliding in the central plane.

11. The mounting system according to claim 10, wherein the second end portion is a unified structure with the central portion and the first end portion is selectively connectable to the central portion.

12. The mounting system according to claim 11, wherein the second end portion is bendable into the L-shape, the second end portion having a first bending feature between the central portion and the base leg and a second bending feature between the base leg and the outer leg, the first bending feature allowing the base leg to be bent to the forwardly extending position and the second bending feature allowing the formation of the L-shape.

13. The mounting system according to claim 12, wherein the second leg further includes a third bending feature adjacent the second bending feature and between the base leg and outer leg, the second and third bending features allowing for a first and a second spacing between the central plane and the outer plane.

14. The mounting system according to claim 12, wherein the first end portion further includes a mounting tongue extending from the first base leg and transverse to the first base leg, the mounting tongue being selectively connectable to the first end of the central portion.

15. The mounting system according to claim 14, wherein the mounting tongue is shaped to be received in the inwardly extending first and second side channels of the panel strap to join the first end portion to the central portion.

16. The mounting system according to claim 15, wherein the first end portion is bendable into the L-shape, the first end portion having a first bending feature between the mounting tongue and the base leg and a second bending feature between the base leg and the outer leg, the first bending feature allowing the base leg to be bent to the forwardly extending position and the second bending feature allowing the formation of the L-shape.

17. The mounting system according to claim 16, wherein the first leg further includes a third bending feature adjacent the second bending feature and between the base leg and outer leg, the second and third bending features allowing for a first and a second spacing between the central plane and the outer plane.

18. The mounting system according to claim 17, wherein the central portion has a central portion length and the central portion length is adjustable, the first end portion being connectable to the central portion after the central portion is adjusted.

19. The mounting system according to claim 17, wherein at least one of the bending features includes a linearly extending series holes.

20. The mounting system according to claim 1, wherein the first end portion, a second end portion and the central portion are formed from sheet metal, the panel strap being formed by a polymer.

21. The mounting system according to claim 1, wherein the first end portion is bendable into an L-shape, the first end portion having a base leg joined to an outer leg with a bending feature separating the base leg from the outer leg to form the L-shape.

22. The mounting system according to claim 21, wherein the bending feature is a first and a second feature to adjust the length of the base leg between a first length and a second length.

23. The mounting system according to claim 1, wherein the at least one conduit is a plurality of conduits.

24. The mounting system according to claim 23, wherein the plurality of conduits includes an electrical conduit.

25. The mounting system according to claim 23, wherein the plurality of conduits includes an non-electrical conduit.

26. The mounting system according to claim 3, wherein the associated first and second structural objects are adjacent studs in a stud wall and the outer plane is generally aligned with the associated stud wall, the first and second outer legs including fastener opening for securing the mounting system to the adjacent studs.

27. The mounting system according to claim 1, wherein the first and second ends of the at least one clip define the overall length of the at least one clip.

28. A mounting system for securing at least one conduit to a structural object, the conduit having a central conduit axis and an outer layer extending about the conduit axis, the system comprising:
a first bracket element including a first end portion, the first end portion being L-shaped having a first base leg and a first outer leg joined to the base leg, the outer leg extending in an outer plane, the first bracket element further including a mounting tongue extending from the first base leg and transverse to the first base leg, the mounting tongue extending generally parallel to the outer plane;
a second bracket element including a central bracket portion extending in a central plane and a second end portion, the second end portion being L-shaped having a second base leg and a second outer leg joined to the second base leg, the second outer leg extending in the outer plane spaced from the first outer leg, the central portion including strap support rails;
a panel strap shaped to be received in the strap support rails to secure the panel strap relative to the central portion of the second bracket element, the panel strap including a base plate and inwardly extending first and second side channels, the first and second side channels of the panel strap each including inner edges facing one another thereby defining a clip receiving gap, the each channel further including outer side walls spaced from one another by an end wall spacing and facing one another, the clip receiving gap being less than the end wall spacing; and,
at least one clip having a longitudinally extending clip body extending between a first and a second clip end thereby defining a clip length, the at least one clip including a conduit receiving cavity extending about a cavity axis such that the cavity includes a conduit receiving slot parallel to the cavity axis, the conduit receiving cavity being shaped to receive an associated conduit, the at least one clip further including a first longitudinally extending flange at the first end and a second longitudinally extending flange at the second end, the first flange having a first transverse outer edge at least partially defining the first end and the second flange having a second transverse edge at least partially defining the second end, the first flange further including a first corner portion and a second corner portion, the second flange including a third corner portion and a fourth corner portion such that the first corner portion is cattycornered to the third corner portion defining a clearance length of the clip and the second corner portion is cattycornered to the fourth corner portion defining a locking length of the clip, the clearance length being less than the locking length and less than the clip receiving gap such that the at least one clip can be received in the panel strap, the locking length being greater than the end wall spacing of the panel strap wherein the at least one clip can be rotated relative to the panel strap to substantially lock the at least one clip relative to the panel strap, the mounting tongue being selectively joinable to at least one of the central portion and the panel strap.

29. The mounting system according to claim 28, wherein the panel strap slidingly engaging the spaced apart support rails, the support rails being on a front face of the central portion, the, the first and second base legs preventing the panel strap from sliding in the central plane, the mounting tongue is shaped to be received in the inwardly extending first and second side channels of the panel strap to join the first bracket element to the second bracket element.

30. The mounting system according to claim 29, wherein the second end portion is bendable into the L-shape, the second end portion having a first bending feature between the central portion and the base leg and a second bending feature between the base leg and the outer leg, the first bending feature allowing the base leg to be bent to the forwardly extending position and the second bending feature allowing the formation of the L-shape, the first end portion is bendable into the L-shape, the first end portion having a first bending feature between the mounting tongue and the base leg and a second bending feature between the base leg and the outer leg, the first bending feature allowing the base leg to be bent to the forwardly extending position and the second bending feature allowing the formation of the L-shape.

31. The mounting system according to claim 30, wherein the first and second end portions further include a third bending feature adjacent the second bending feature and between the base leg and outer leg, the second and third bending features allowing for a first and a second spacing between the central plane and the outer plane.

32. A mounting system for securing at least one conduit to a structural object, the conduit having a central conduit axis and an outer layer extending about the conduit axis, the system comprising:
a first bendable bracket element including a first end portion, the first end portion being shapeable into an L-shape having a first base leg and a first outer leg joined to the base leg separated by a first bending feature, the outer leg extending in an outer plane in the bent condition, the first bracket element further including a mounting tongue extending from the first base leg and separated from the first base leg by a second bending feature such that the tongue is bendable to be generally parallel to the outer plane;
a second bendable bracket element including a central bracket portion extending in a central plane and a second end portion, the second end portion being shapeable into an L-shape having a second base leg and a second outer leg joined to the second base leg, the second bendable bracket having a third bending feature between the central portion and the second base leg such that the second base leg is bendable relative to the central portion, the second bracket element further including a fourth bending feature between the second base leg and the second outer leg such that the second outer leg is bendable to align the second outer leg in the outer plane and form the L-shape, the second outer leg being spaced from the first outer leg, the central portion including strap support rails;
a panel strap shaped to be received in the strap support rails of the central portion to secure the panel strap relative to the central portion of the second bracket element, the panel strap including a locking rail to support a plurality of conduit clips; and,
at least one conduit clip having a longitudinally extending clip body extending between a first and a second clip end thereby defining a clip length, the at least one clip including a conduit receiving cavity extending about a cavity axis such that the cavity includes a conduit receiving slot parallel to the cavity axis, the conduit receiving cavity being shaped to receive an associated conduit, the at least one clip being lockable in the locking rail of the panel strap.

33. A method of mount a conduit to a structural object, the method comprising the steps of:
providing a first bracket element including a first end portion, the first end portion being L-shaped having a first base leg and a first outer leg joined to the base leg, the outer leg extending in an outer plane, the first bracket element further including a mounting tongue extending from the first base leg and transverse to the first base leg, the mounting tongue extending generally parallel to the outer plane;
providing a second bracket element including a central bracket portion extending in a central plane and a second end portion, the second end portion being L-shaped having a second base leg and a second outer leg joined to the second base leg, the second outer leg extending in the outer plane spaced from the first outer leg, the central portion including spaced apart strap support rails;
providing a panel strap shaped to be received in the spaced apart support rails to secure the panel strap relative to the central portion of the second bracket element, the panel strap including a base plate and inwardly extending first and second side channels, the first and second side channels of the panel strap each including inner edges facing one another thereby defining a clip receiving gap, the each channel further including outer side walls spaced from one another by an end wall spacing and facing one another, the clip receiving gap being less than the end wall spacing;
sliding the panel strap into the spaced apart strap support rails in the central portion;
securing the tongue to at least one of the central portion and the panel strap;
providing at least one clip having a longitudinally extending clip body extending between a first and a second clip end thereby defining a clip length, the at least one clip including a conduit receiving cavity extending about a cavity axis such that the cavity includes a conduit receiving slot parallel to the cavity axis, the conduit receiving cavity being shaped to receive an associated conduit, the at least one clip further including a first longitudinally extending flange at the first end and a second longitudinally extending flange at the second end, the first flange having a first transverse outer edge at least partially defining the first end and the second flange having a second transverse edge at least partially defining the second end, the first flange further including a first corner portion and a second corner portion, the second flange including a third corner portion and a fourth corner portion such that the first corner portion is cattycornered to the third corner portion defining a clearance length of the clip and the second corner portion is cattycornered to the fourth corner portion defining a locking length of the clip, the clearance length being less than the locking length and less than the clip receiving gap such that the at least one clip can be received in the panel strap, the locking length being greater than the end wall spacing of the panel strap wherein the at least one clip can be rotated relative to the panel strap to substantially lock the at least one clip relative to the panel strap;
securing the first and second end portions to an associated structural object; and,
securing the at least one clip to the panel strap.

34. The method according to claim 33, wherein the second end portion is bendable into the L-shape, the second end portion having a first bending feature between the central portion and the base leg and a second bending feature between the base leg and the outer leg, the first bending feature allowing the base leg to be bent to the forwardly extending position and the second bending feature allowing the formation of the L-shape, the first end portion is bendable into the L-shape, the first end portion having a first bending feature between the mounting tongue and the base leg and a second bending feature between the base leg and the outer leg, the first bending feature allowing the base leg to be bent to the forwardly extending position and the second bending feature allowing the formation of the L-shape, the method further including the steps of bending the first and second end portions about the bending features to produce the L-shapes.
